(19) United States
(12) Patent Application Publication
(10) Pub. No.: US 2019/0109709 A1
(43) Pub. Date: Apr. 11, 2019

(54) SYSTEM AND METHOD FOR CREATING AND TRANSFERRING DIGITAL TOKENS CRYPTOGRAPHICALLY WITHOUT THE NEED FOR PERIODIC CENTRALIZED AUTHORIZATION TO RECORD TRANSACTIONS

(71) Applicant: Wenqing Wu, San Diego, CA (US)

(72) Inventor: Wenqing Wu, San Diego, CA (US)

(21) Appl. No.: 16/147,887

(22) Filed: Oct. 1, 2018

Related U.S. Application Data
(60) Provisional application No. 62/568,774, filed on Oct. 5, 2017.

(51) Int. Cl. H04L 9/08; H04L 9/06; G06Q 20/40; H04L 9/30

(52) U.S. Cl. CPC H04L 9/0861; H04L 9/30; G06Q 20/401; H04L 9/0643

(57) ABSTRACT

The present invention is directed to a non-transitory machine-readable storage medium containing program instructions for creating and transferring digital tokens cryptographically without the transaction recording need for periodic centralized authorization by configuring said non-transitory machine-readable storage medium to:
1) generating a transaction consent for token creation or transfer, said transaction consent contains token information of where to get the transaction approved, in forms of web URLs, email addresses, or SMS phone numbers etc., and how to verify the approval, in the form of digital signature verification with token ID serving as cryptographic signature public key. Said transaction consent is digitally signed by transaction initiators; and
2) directing said transaction consent to appropriate transaction approval node; and
3) validating said transaction consent and forming a corresponding transaction record, said transaction record is digitally signed that can be validated by the cryptographic signature public key which is made to delegate said token in said transaction and made to be known to token recipients via said token information in said token consent.

To make said digital token general purpose, said transaction consent may also contain information of task/liability fulfillment inspectors, privilege/permission granters, future transfer signature requirements and timing constraints for implementing functions such as task/liability tracking and releasing, privilege/permission tracking and granting, installment payment fulfillment and revocation etc. The transaction system of the present invention also comprises nodes for publishing access information of token transaction approval servers, so that token transaction clients may retrieve latest up-to-dated access information.

### CROSS-REFERENCE TO RELATED APPLICATIONS

The present application claims the benefit of the provisional application bearing Ser. Mo. 62/568,774 filed Oct. 5, 2017, entitled “SYSTEM AND METHOD FOR CREATING AND TRANSFERRING GENERAL PURPOSE DIGITAL TOKENS CRYPTOGRAPHICALLY WITHOUT THE NEED FOR PERIODIC CENTRALIZED AUTHORIZATION OF TRANSACTION DATABASE SYNCHRONIZATION.”

### BACKGROUND

The present invention relates generally to a system and method for creating and transferring digital tokens cryptographically with token specific authorization for database authorization over distributed token networks that is defined at token creation time.

In comparison, prior art systems and methods, such as the ones adopted by Bitcoin and Ethereum, authorize the recording of token creation and transfer in a synchronized scheme across the distributed token network. FIG. 1 shows the architecture of such prior art system.

Continue on FIG. 1, the prior art system comprises plural transaction recording nodes 102, and 122, and plural transaction clients 112, and 132. The transaction client 112 (or 132) is made aware of the transaction records 114 (or 134) for the tokens it received. To transfer a token a client such as client 132 received previously, client 132 references to the transaction it received and signs the transfer request with the required signature as indicated in the received transaction. Client 132 then passes the signed token transfer request to the recipient token transaction client such client 112. To its own interest, the receiving token transaction client 112 broadcasts 120 the received signed token transfer request to as many token transaction recording nodes 102 and 122 as it may reach, and then polling with 138 the transaction recording nodes to see if the token transfer transaction has been recorded into the databases across the recording nodes.

With reference to FIG. 1, each transaction recording node may in turn comprise one token database, such as database 104 for recording node 102, database 124 for recording node 122. The token database is the data store for token transaction records and may be used to serve queries of token transaction. Each database within a recording node is shared across the plural blockchain mining servers within the same recording node, such as database 104 is shared across mining servers 108 and 110, and database 124 is shared across mining servers 128 and 130. The job of the mining servers is to collect the new transaction recordings from transaction clients such as 112 and 132, and then to find a special number like the winning number in a lottery so that the hash of that number and the collected new transactions meet certain difficulty requirement, hence allowing the recording node with the special number to win the recording authority for the collected new transactions. The winning recording node such as 102 or 122 then records the collected new transactions, including token creation transactions, and then pushes the new record to other recording nodes such as to recording nodes 122 or 102 to force all the databases to stay the same across all recording nodes, which is known as database synchronization.

From the foregoing description, it may be readily seen that there is an intrinsic processing/recording bottle neck in the prior art system 100: the synchronization of the databases across recording nodes for a new transaction record is centralized. At any given point in time or in blockchain height, a new transaction record (a new block attached to the existing blockchain) has to be originated from a solely authorized recording node with a winning number, this is a serial process that does not allow simultaneous recording of multiple new records (new blocks on the blockchain) created by multiple recording nodes, even though the system is intended to be distributive. Furthermore, to make the recording difficulty to be tampered with, the winning number is purposely made difficult to find (mine). The predefined protocol in the system moderates the difficulty such that on average it takes the predefined delay to find (mine) a winning number, hence makes it periodic to authorize a recording node to record the new transactions into the system in form of a new block attached to the top of the existing blockchain. In contrast, the present invention provides the capabilities of real time or near real time recording of new transactions into the system.

The present invention with system architecture shown in FIG. 2 is especially designed to address the drawbacks in the prior art system as shown in FIG. 1. It is accomplished by eliminating the transaction recording need for periodic and centralized authorization.

Due to the foregoing reasons, the prior art scheme is difficult to record token transactions at scale and in real time, whereas the present invention offers the capability to real time recording of token transactions, and scalability with the number of recording nodes.

### SUMMARY

The present invention is directed to a non-transitory machine-readable storage medium containing program instructions for recording digital token transfers cryptographically without the need for periodic centralized authorization to record transactions. The non-transitory machine-readable storage medium is configured to record token transaction records into appropriate transaction validation and approval servers in real time.

According to another aspect of the present invention, a computer implemented method for creating and transferring digital tokens directs the recording of said transactions to transaction servers responding for the said transacting digital tokens, then signs and records the transaction records with the private keys corresponding to the said transacting digital tokens after validating the transactions. The transaction record submitting clients are fed back with the status of transaction record recording. All these are done in real time without predefined systematic delays. Lottery winning schemes such as POW (proof of work) or POS (proof of stake) are neither necessary nor used for authorizing the recording of the new transaction records in the present invention.

### BRIEF DESCRIPTION OF THE DRAWINGS

These and other features, aspects, and advantages of the present invention will become better understood with regard to the following description, appended claims, and accompanying drawings where:

FIG. 1 depicts the system architecture of prior art for recording digital token creation and transfer with periodic centralized recording authorization using schemes of proof of work (POW) or proof of stake (POS);

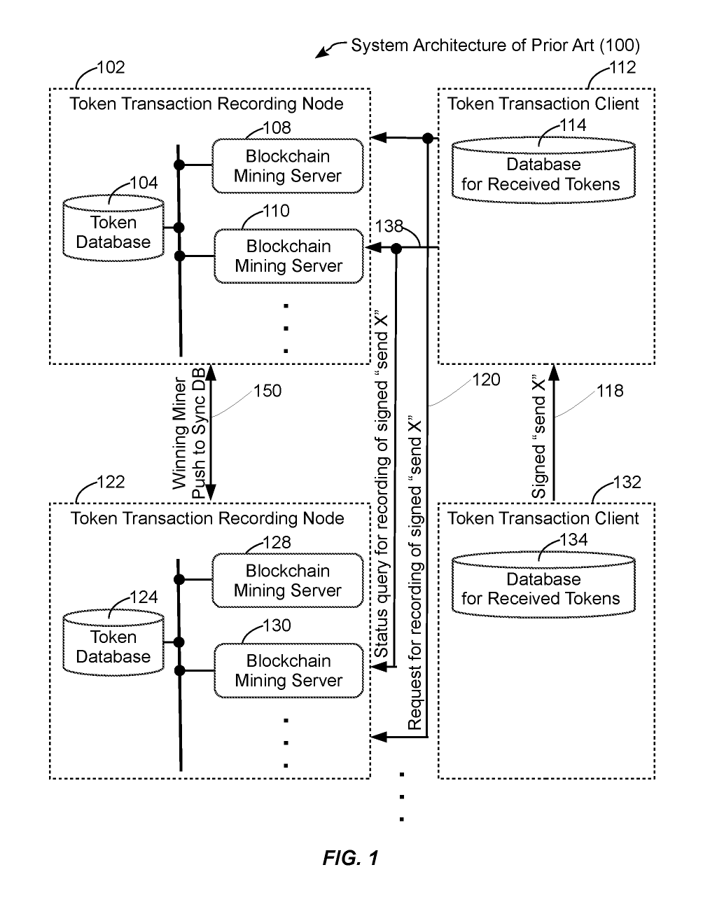

FIG. 2 illustrates the system architecture of one embodiment of the present invention for recording digital token creation and transfer without the need for periodic centralized authorization to record transactions;

FIG. 3 shows the flow chart for sever processes of one embodiment of the present invention to accomplish the functions of the present invention;

FIG. 4 shows the flow chart of client processes in one embodiment of present invention for implementing the utilities of the present invention;

FIG. 5 depicts an exemplary use of tokens based on the present invention for task/liability tracking and releasing;

FIG. 6 shows an exemplary use of tokens based on present invention for privilege/permission tracking and granting;

FIG. 7 shows an exemplary design of user interface (UI) on system clients to create tokens for task tracking/releasing;

FIG. 8 illustrates an exemplary design of user interface (UI) on system clients to create tokens for privilege tracking/granting.

### DETAILED DESCRIPTION

In the Summary above and in the Detailed Description, and the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature may also be used, to the extent possible, in combination with and/or in the context of other particular aspects and embodiments of the invention, and in the invention generally.

An aspect of the present invention is directed to a system for cryptographically recording transactions of digital tokens without the need of periodic and centralized authorization, thus eliminate the processing bottle neck in cryptographic token systems such as Bitcoin and Ethereum, where transactions recording authorization is periodic and centralized in form of mining a winning number, which consumes significant amount of energy, time, and computational power. The system of the present invention associates digital tokens with corresponding transaction approval servers. Upon each token transaction, such as token transfer or token creation, transaction consent is signed by the transaction originator, which is the token transferor in case of token transfer, or the token creator in case of token creation, then the transaction-originator-signed transaction consent is sent to corresponding transaction servers, where the transaction is validated for the correctness, making sure no double-spending, and then signed with the corresponding transaction approval signatures for the transactions to be considered as recorded, so that the recipients may use said approval signature as evidence of transaction approval and transaction recording.

To facilitate the comprehension of the present invention, throughout the specification for the present invention, digital tokens may be viewed in analogy to a stocks, such as AAPL and GE, while the amount of a token may be viewed in analogy to the shares of a stocks, such as 500 shares of AAPL, 10 shares of GE, and to some extend the transaction approval nodes may be viewed in analogy to stock exchanges such as NYSE and NASDAQ.

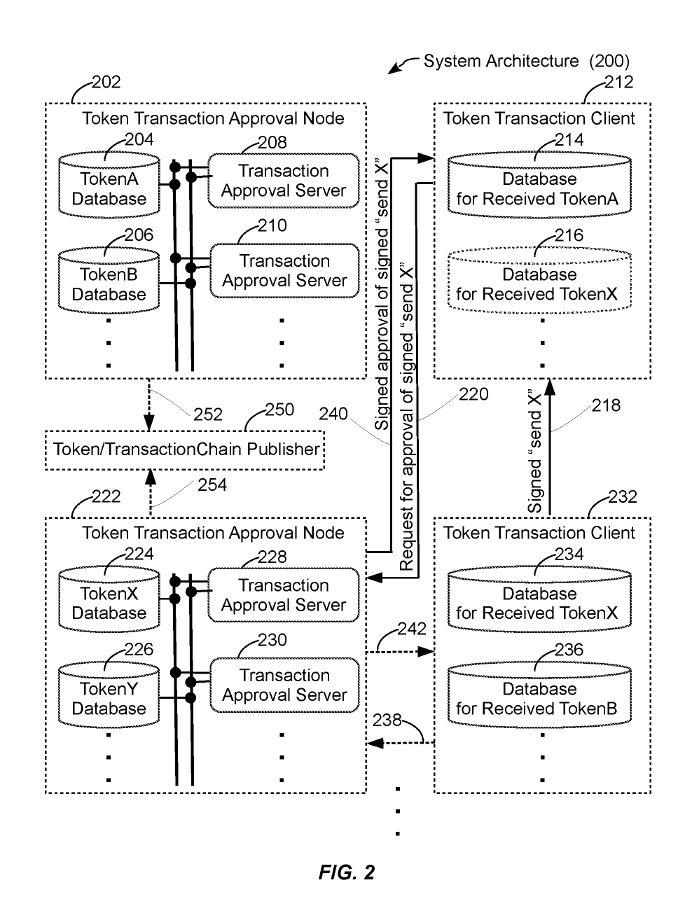

Illustrated in FIG. 2. is an embodiment of the present invention as applied to a system to cryptographically record transactions of digital token in real time, not periodically with systematic intervals and without centralized recording authorization. Referring now to FIG. 2, the system includes plural transaction approval nodes with only two are shown as in FIGS. 2. as 202 and 222, the system also includes plural transaction clients with only two are shown as in FIGS. 2. as 212 and 232. In each transaction approval node, there are plural transaction approval servers, such as transaction approval servers 208 and 210 in transaction approval node 202, transaction approval servers 228 and 230 in transaction approval node 222. In each transaction approval node, there are also plural data stores for recording the transactions of all the tokens the transaction approval node 222 is responsible for, such as, in transaction approval node 202, there is one data store 204 for TokenA, another data store 206 for TokenB, and in transaction approval node 222, there is one data store 224 for TokenX, another data store 226 for TokenY. The data stores are shared across the transaction approval servers within a transaction approval node, such as TokenA data store 204 and TokenB data store 206 are shared across transaction approval servers 208 and 210, while TokenX data store 224 and TokenY data store 226 are shared across transaction approval servers 228 and 230. In one embodiment, each transaction client may have data stores for received tokens, such as data store 214 for received TokenA and data store 216 for received TokenX are present in transaction client 212, data store 234 for received TokenX and data store 236 for received TokenB are present in transaction client 232. These client data stores contain information needed for transferring the received tokens, such information comprises source transaction records, amount available for transfer, transfer consent signature keys, and signature requirements and transfer timing constraints etc. In case the transaction client is also the ultimate approval source for proxified tokens, the cryptographic signature keys for transaction approval may also be stored on transaction client. In another embodiment, the transaction clients may not need to store the data stores for the received tokens, the transaction clients are just made to have accesses to the information necessary for transferring the received tokens.

Continue on FIG. 2, as an example of token transfer, when transferring TokenX from token transaction client 232 to token transaction client 212, token transaction client 232 retrieves transferor's cryptographic private keys and the transaction records for the received TokenX from data store 234, then form a transfer consent, which contains the information of the said transaction records for said received TokenX, token ID that also serves as the public key for verification of transaction approval signatures, and the public keys of token recipients so that only the recipients can sign a transaction consent that transfers tokens originated from the transfer consent that is being formed. Said transfer consent is then signed using said transferor's cryptographic private key which can be verified by the public keys of token recipients stated in the said transaction record for said received TokenX. Then token transaction client 232 passes the signed token transfer consent to the recipient token transaction client 212 as depicted by 218. In one embodiment of the present invention, the recipients may not be required to add their signatures to the transaction consent, while in another embodiment of the present invention the recipients may be required to add their signatures to the received transaction consent to form a complete transaction consent with signatures from all parties for the transaction to be eligible for approving by appropriate transaction approval nodes. The signatures may be made by cryptographically signing over token information, transaction outputs, and transaction inputs. An embodiment of the present invention may implement the digital token to possess the information of where to have the token transaction approved (in forms of web URLs, email addresses, or SMS phone numbers etc.) and how to verify the approval. So, from the digital token itself, the recipient knows the addresses of the approval nodes and the cryptographic keys for verifying the transaction approval signatures. It is to the interest of the token transaction client 212 that receives the token transfer to forward the signed token transfer consent to the appropriate transaction approval node 222 as illustrated by 220. The approval node 222 then checks the transaction to make sure it is valid and no double-spending of tokens, or no conflicts, and is signed with token key in case of token creation (a special case of token transfer in the present invention). If all the aforementioned conditions are met, then the approval node 222 approves the transaction by signing the transfer consent with the cryptographic signing key that is designated for approving transactions of the token being transferred, then feeds back the signed approval to the recipient as in 240 to complete the transaction (approval and recording). The recipient node 212 stores the signed approval along with the received transfer consent in data store 216. A transaction client such as 232 may query a transaction approval server such as 222 to see a transaction consent has been approved for a token the transaction approval server 222 is responsible for approving. A token transaction client such as 232 may request a token approval server such as 222 to create a token via 238, such token may be created as hosted, i.e., the token approval node creates and stores the token transaction approval cryptographic signature keys, or may be created as proxified, i.e., the token transaction client that requesting token creation creates and stores the token transaction approval cryptographic signature keys. The token ID for the token to be created may be the public key that is used for verification of token transaction approval cryptographic signatures, or may be an alias of said cryptographic signature public key with the mapping of the alias to said cryptographic signature public key is stored in a place that is accessible to the parties in said transaction. The token creation consent is formed with said token ID, creator's cryptographic public key for the creator as token recipient, in addition other information. Said token creation consent is then signed using creator's own cryptographic private keys which can be verified by said cryptographic public key stated in the said token creation consent. To approval a transaction, a token approval node may request 242 approval signatures from appropriate token transaction client for proxified tokens that the token approval node serves as a proxy of the said token transaction client. Upon approving/recording of one or more transactions, each transaction approval node may form a transactionchain. Said transactionchain is formed by including in said transaction record the hash of the transaction that is at the end of the transaction chain at the time, with the exception of the 1^{st} transaction in a transaction chain which does not need to include the hash of another transaction. The transaction approval signature is made by signing over said the transaction record that includes the chaining transaction hash. Said transactionchain is then published on token/transactionchain publisher 250 via transactionchain pushes 252 and 254. This serves as a safeguard against security breach at transaction approval nodes that hackers have obtained access to the approval signing private key and hence may approve invalid transactions in parallel to the approval processes in token approval nodes 202 and 222. If such security breach happens, starting from some point in the transactionchain, a transaction would have at least two descendants, one approved by the true approval key owner, the others are approved by the hackers, this is known as transactionchain fork. The transactionchain fork would reveal the security breach and invalidate the transactions starting at the fork, preventing the security breach from damaging the integrity of the system. Furthermore, to protect the tokens prior to distributing to end users, tokens may always be transferred to multiple addresses at creation time.

As an advanced option for network robustness, token transaction approval servers 202 and 222 may also publish the access information (such as IP addresses, approval service/API access URL, email addresses etc.) of token transaction approval servers onto token/transactionchain publishers 250 for the tokens the corresponding token transaction approval server serves, the published token transaction approval server access information is signed and the corresponding cryptographic signature is made with corresponding token ID, or its derivatives, as signature verification key, hence allowing the signature to be validated with token ID itself. This enables token transaction approval servers to be changed/moved/replaced so to have different service access IP addresses, URLs, and email addresses etc. This enables a token transaction client to look up the latest up-to-dated token transaction approval server access information for a given token from token/transactionchain publishers 250 and send transaction consents to corresponding transaction approval servers accordingly.

The approval status of a transaction may also be queried (by a transaction client, or anyone) at token/transactionchain publishers 250, a transaction is considered approved if it is recorded in the transactionchain for the said token, and it is considered a valid completed transaction if it is in the transactionchain and has no transactionchain forking prior to the transaction.

It is worth pointing out that token/transactionchain publishers 250 may not necessarily to have each of such publishers to serve both the function as a token publisher and the function as a transactionchain publisher. In practice, the function as a token publisher and the function as a transactionchain publisher may be implemented in different servers/publishers, and may also be implemented in clients as well in a way like a BitTorrent network.

Moreover, in one embodiment of the present invention, in addition to token information with token ID for validating transaction approval signatures, said transaction consent may comprise transaction inputs, which specify the amount of the token to be transferred and its corresponding sources that may be in the form of the IDs or hashes of the transaction records from where the transferor received the token. Said transaction consent may also comprise transaction outputs, which specify transferees and corresponding amounts. The cryptographical public key of the transferees may be specified in said token outputs so that their cryptographical signatures can be verified when they make transfers of the token they have received. Advanced transaction outputs may also contain digital signature requirements for future transfers of the token being transferred, said signature requirements may include time specification such that installment payments may be implemented, and revocation of installment payments, be it partial or full, may be realized. Said transferor may then create the consent signature by cryptographically signing over token information, transaction inputs, and transaction outputs. Said transaction consent is always sent or stored along with its corresponding consent signature so that its validity can be verified. In another embodiment of the present invention, the signatures of recipients may also be required to be sent along with said transaction consent as a mechanism to prevent unwanted transfers, said recipient signatures may be made by cryptographically signing over token information, transaction inputs, and transaction outputs with the cryptographical signing private keys of said recipients.

In another embodiment of the present invention, the access information of a transaction approval server for a given token is signed with corresponding token ID that servers as the signature verification public key of approval signatures. Said signed access information is then sent to token publishers so that said access information may be looked up by transacting clients and by transaction forwarding nodes, hence allowing relocation of transaction approval nodes.

Therefore, with the architecture as depicted in FIG. 2, the token transaction system may be supported by software and hardware from anyone, as long as they follow the transaction protocols described in the present invention. This is unlike existing cryptocurrency networks, such as Bitcoin and Ethereum, that the network software has to come from special interest groups, which essentially centralizes the control of the transaction networks, defeating the original goal of a distributed transaction network.

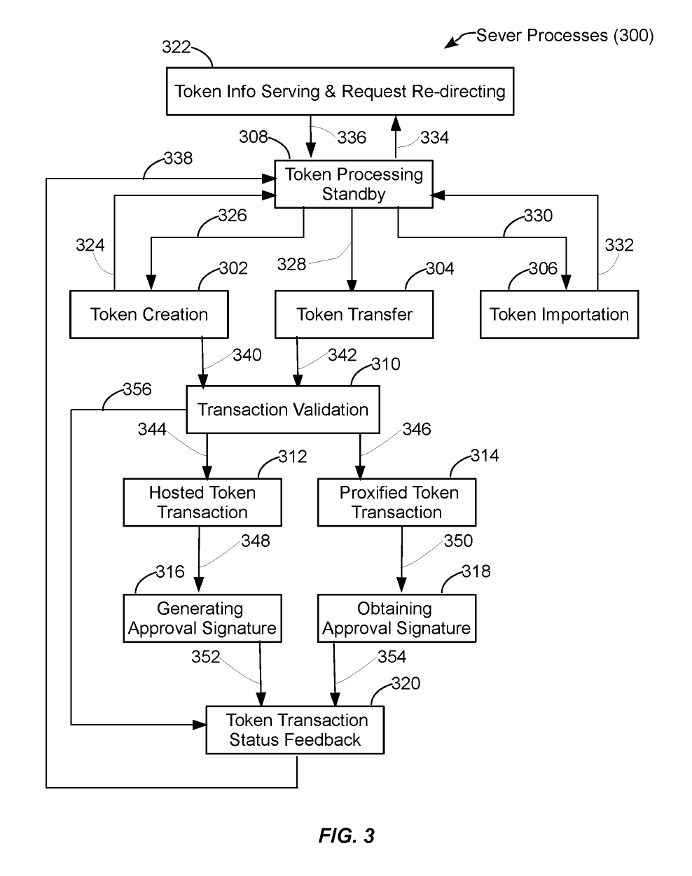

Referring to FIG. 3 for the exemplary processes (300) that run on the transaction approval servers in a token transaction approval node. A token approval server is generally in a standby state 308. Depends on the requests it receives, a token approval server may transit into various states. When a token approval server receives an information query for a token that the transaction approval node is responsible for, the token approval server transits 334 to the information serving state 322, where appropriate token information is retrieved from the information local stores and served to the requesting parties, and then transits 336 back to the token processing standby state 308. When a token approval server receives a request for tokens that the token approval node is not responsible for, the token approval server transits 334 into redirecting state 322, where the requesting parties are redirected to elsewhere appropriately, and then transits 336 back to token processing standby state 308. When a token approval server receives a legitimate token import request, it transits 330 into token importation state 306, where appropriate token information is retrieved from appropriate sources and stored local to the approval node, when done, the token transaction approval server transits 332 back to token processing standby state 308. When a token approval server receives a token creation request, it transits 326 into token creation state 302, where the server is configured for token creation, then the server transits 340 into transaction validation state 310, where the token creation request is validated for permission, security, and conflicts etc. If the token creation does not pass the validation, then the token approval server transits 356 to token transaction status feedback state 320, where the requesting parties are informed of the invalidity of the token creation transaction. If the token creation passes the validation, then the token approval server transits 344 into hosted token transaction state 312 if the token is a hosted token, otherwise the token approval server transits 346 into proxified token transaction state 314 if the token is a proxified token. In hosted token transaction state 312, the token approval server is configured to sign the approval with the cryptographic signature key that can be validated with the token ID and is retrieved locally from the designated token approval node, then the designated token approval server transits 348 to approval signature generation state 316 and gets the token creation transaction signed with said approval cryptographic signature key, then transits 352 to token transaction status feedback state 320 to inform the requesting parties of the status and the approval signature of the requested token creation transaction. After passing validation of token creation in transaction validation state 310, a token approval server transits 346 into proxified token transaction state 314 if the token is a proxified token, where the token approval server is configured to obtain the token creation approval signature externally by transiting 350 to approval signature retrieval state 318 and get the token creation transaction signed by appropriate external sources, then transits 354 to token transaction status feedback state to inform the requesting parties of the status and the approval signature of the requested token creation transaction. When token transaction status feedback state is done, a token approval server transits 338 back to token processing standby state 308.

Continue on FIG. 3, when a token approval server receives a token transfer request, it transits 328 into token transfer state 304, where the server is configured for token transfer, then the server transits 342 into transaction validation state 310, where the token transfer request is validated for permission, security, sufficient balance, and proper transfer consent signature etc. If the token transfer does not pass the validation, then the token approval server transits 356 to token transaction status feedback state 320, where the requesting parties are informed of the invalidity of the token transfer transaction. If the token transfer passes the validation, then the token approval server transits 344 into hosted token transaction state 312 if the token is a hosted token, otherwise the token approval server transits 346 into proxified token transaction state 314 if the token is a proxified token. In hosted token transaction state, the token approval server is configured to sign the approval with the cryptographic signature key that can be validated with the token ID and is retrieved locally from the designated token approval node, then the designated token approval server transits 348 to approval signature generation state 316 and gets the token transfer transaction signed with said approval cryptographic signature key, then transits 352 to token transaction status feedback state 320 to inform the requesting parties of the status and the approval signature of the requested token transfer transaction. After passing validation of token transfer in transaction validation state 310, a token approval server transits 346 into proxified token transaction state 314 if the token is a proxified token, where the token approval server is configured to obtain the token transfer approval signature externally by transiting 350 to approval signature retrieval state 318 and then get the token transfer transaction signed by appropriate external sources, then transits 354 to token transaction status feedback state to inform the requesting parties of the status and the approval signature of the requested token transfer transaction. When done in token transaction status feedback state, a token approval server transits 338 back to token processing standby state 308.

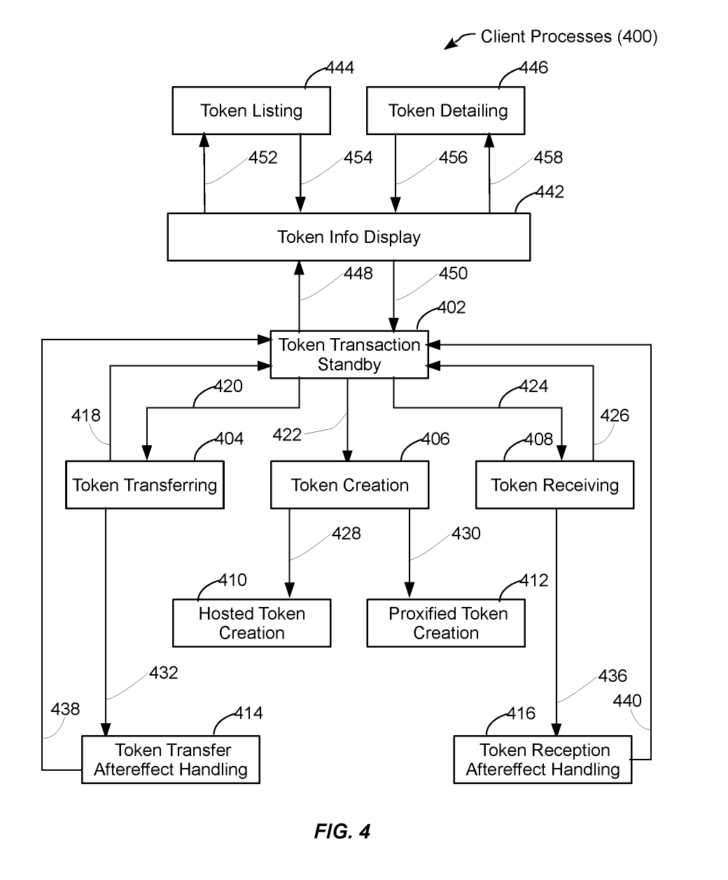

The exemplary client processes 400 for token transaction are shown in FIG. 4. A token transaction client typically stays in token transaction standby state 402. When a token transaction client receives a user request for display token info, the token transaction client transits 448 into token info display state 442. If listing of portfolio tokens is requested, the token transaction client enters 452 into token listing state 444, where the tokens that the user owns are displayed as a list. When the listing is done, the token transaction client returns 454 back to token info display state 442. If it is the displaying of detailed information of a token is requested by the user, the token transaction client enters 458 token detailed information display state 446, where the details of the token is displayed, when done, the token transaction client transits 456 back to token info display state 442. When token information display task is done in token info display state 442, the token transaction client returns 450 back to token transaction standby state 402. When a token transaction client receives a user request to transfer owned tokens to some recipients, the token transaction client enters 418 token transferring state 404, where received token records and corresponding cryptographic signature keys that can authorize transfers of said token are retrieved from either local data stores or from proxy servers, then a token transfer consent with reference to the received token transactions is formed and signed with the appropriate transfer authorization cryptographic signature keys that only the owners of the tokens possess. The signed transfer consent is then passed to recipients, or optionally to appropriate token transaction approval nodes directly for approval, then the token transaction client transits 432 to token transfer aftereffect handling state 414, where appropriate house-keeping procedures such as transaction approval status polling and transaction information recording are executed. When done in token transfer aftereffect handling state 414, said token transaction client returns 438 back to token transaction standby state 402. When a token transaction client needs to handle token reception, it enters 426 token receiving state 408, where the received token transfer consent is checked to see if it contains valid transfer authorization signatures. If the transfer consent is validated for having expected transfer authorization signature, said recipient token transaction client then passes it to appropriate token transaction approval node for the transfer transaction to be approved and recorded. When done in token receiving state 408, a token transaction client enters 436 token reception aftereffect handling state 416, where house-keeping procedures such as transaction information recording, and balance updating are executed. When done in token reception aftereffect handling state 416, said token transaction client returns 440 back to token transaction standby state 402. If a user request for token creation is received when in token transaction standby state 402, said token transaction client enters token creation state 406, where said token transaction client is configured for token creation. Depending the type of token to be created, said token transaction client enters 428 hosted token creation state 410 if hosted token is to be created, or enters 430 proxified token creation state 412 if proxified token is to be created. In hosted token creation state 410, the token creation request is forwarded to an appropriate token transaction approval server, where the token ID and token transaction approval cryptographic signature keys are created and stored. Whereas in proxified token creation state 412, the token ID and token transaction approval cryptographic signature keys are created local to the token transaction client, with the token transaction approval cryptographic signature private key is stored securely local to the token transaction client without disclosing to any other parties, and the token ID and other none secure token inform are passed to token transaction server that acts as a proxy for the token transaction client. In both hosted and proxified cases, said token ID may be the cryptographic signature public key for validating the said transaction approval signatures, so the transaction approvals can be readily verified with said token ID. When done in either hosted token creation state 410 or proxified token creation state 412, said token transaction client may always go back to token transaction standby state 402 (though the transition arcs are not drawn in FIG. 4 due to drawing space limitation).

While there are many practical uses of the digital tokens in the system based on the present invention, only exemplary uses for task (or liability) tracking and releasing, and for privilege (or permission) tracking and granting are given in this description without losing general coverage and direction for other uses.

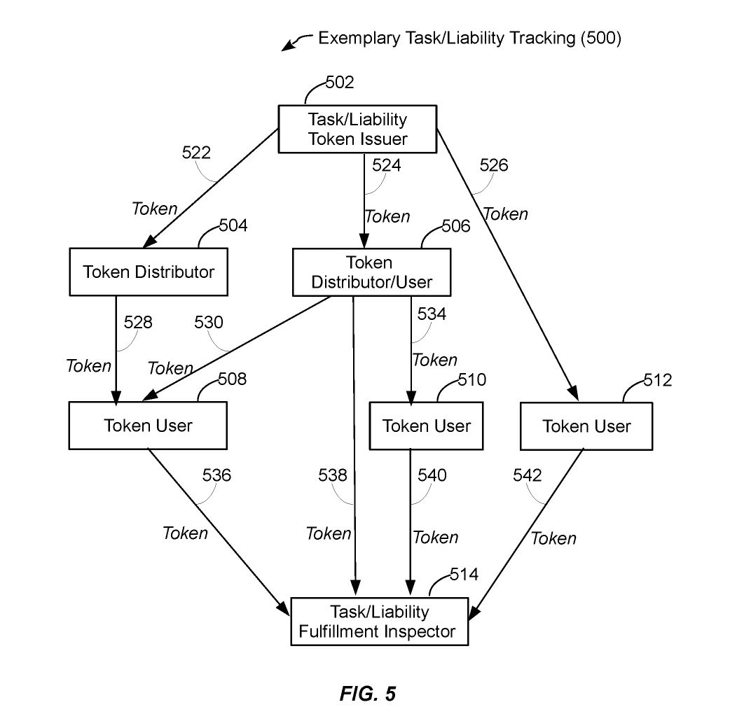

An exemplary use of the digital tokens based on the present invention is depicted in FIG. 5. Task (or liability) issuer 502 creates digital tokens tagged for task (or liability) tracking in a system based on the present invention, then transfers the created task (or liability) tracking tokens to token distributor 504 via token transfer 522, to token distributor/user 506 via token transfer 524, to token end user 512 via token transfer 526. A token end user may receive task (or liability) tracking tokens via token transfers from token distributors and/or directly from token issuers. In one embodiment of the present invention, token end user 508 receives task (or liability) tracking tokens from token distributor 504 via token transfer 528, from token distributor/user 506 via token transfer 530; token user 510 receives task (or liability) tracking tokens from token distributor/user 506 via token transfer 534; token user 512 receives task (or liability) tracking tokens directly from token issuer 502 via token transfer 526. After a task (or liability) has been fulfilled by a token end user, the token end user may transfer the corresponding task (or liability) tracking tokens to task/liability fulfillment inspector 514 to release the responsibility of the task/liability from the token end user. This is illustrated in FIG. 5 as task (or liability) tracking tokens are sent to task/liability fulfillment inspector 514 via token transfer 536 from token end user 508, via token transfer 538 from token distributor and end user 506, via token transfer 540 from token end user 510, and via token transfer 542 from token end user 512. Once said end user transfers all its token for a certain task or liability to the task or liability inspector of said token, the said task or liability of the said user is fulfilled, and the said user is released from the responsibility of the said task or liability. Or the degree of task/liability can be released according to the amount of said tokens the said end user transfers to said task/liability inspector. Optionally, though not drawn in FIG. 5., a token end user can transfer his/her tokens to another token end user, the overall token functionality for tracking/releasing remains the same.

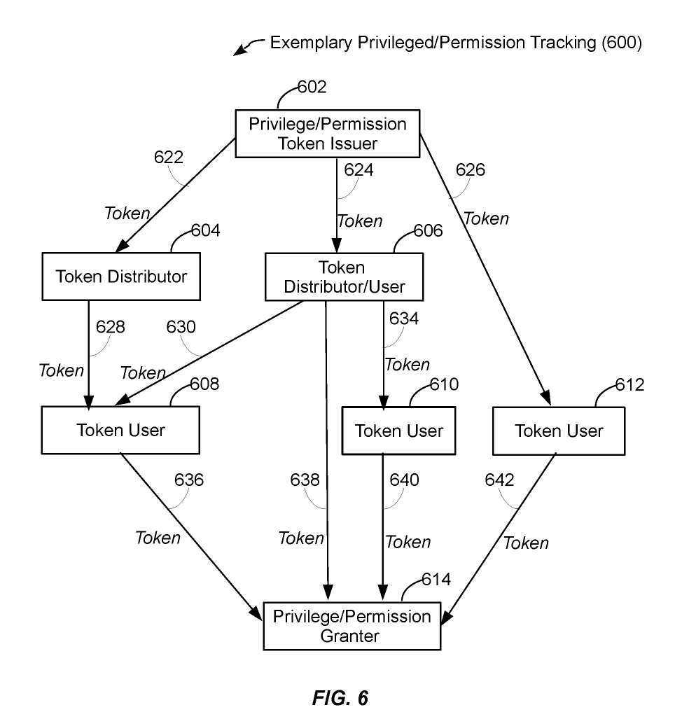

Another exemplary use of the digital tokens based on the present invention is depicted in FIG. 6. Privilege (or permission) issuer 602 creates digital tokens tagged for privilege (or permission) tracking in a system based on the present invention, then transfers the created privilege (or permission) tracking tokens to token distributor 604 via token transfer 622, to token distributor/user 606 via token transfer 624, to token user 612 via token transfer 626. A token end user may receive privilege (or permission) tracking tokens via token transfers from token distributors and/or directly from token issuers. In one embodiment of the present invention, token end user 608 receives privilege (or permission) tracking tokens from token distributor 604 via token transfer 628, from token distributor/user 606 via token transfer 630; token user 610 receives privilege (or permission) tracking tokens from token distributor/user 606 via token transfer 634; token user 612 receives privilege (or permission) tracking tokens directly from token issuer 602 via token transfer 626. To actual receive the grant of privilege or permission, a token end user may transfer the corresponding privilege (or permission) tracking tokens to privilege/permission granter 614 to have corresponding privilege (or permission) granted to the token end user. This is illustrated in FIG. 6 as privilege (or permission) tracking tokens are sent to privilege/permission granter 614 via token transfer 636 from token end user 608, via token transfer 638 from token distributor and end user 606, via token transfer 640 from token end user 610, and via token transfer 642 from token end user 612. Once said end user transfers all its token for a certain privilege or permission to the privilege or permission granter of said token, the said privilege or permission is granted to the said user. Or the degree of privilege/permission can be granted according to the amount of said tokens the said end user transfers to said privilege/permission granter. Optionally, though not drawn in FIG. 6, a token end user may transfer his/her tokens to another token end user, the overall token functionality for tracking/granting remains the same.

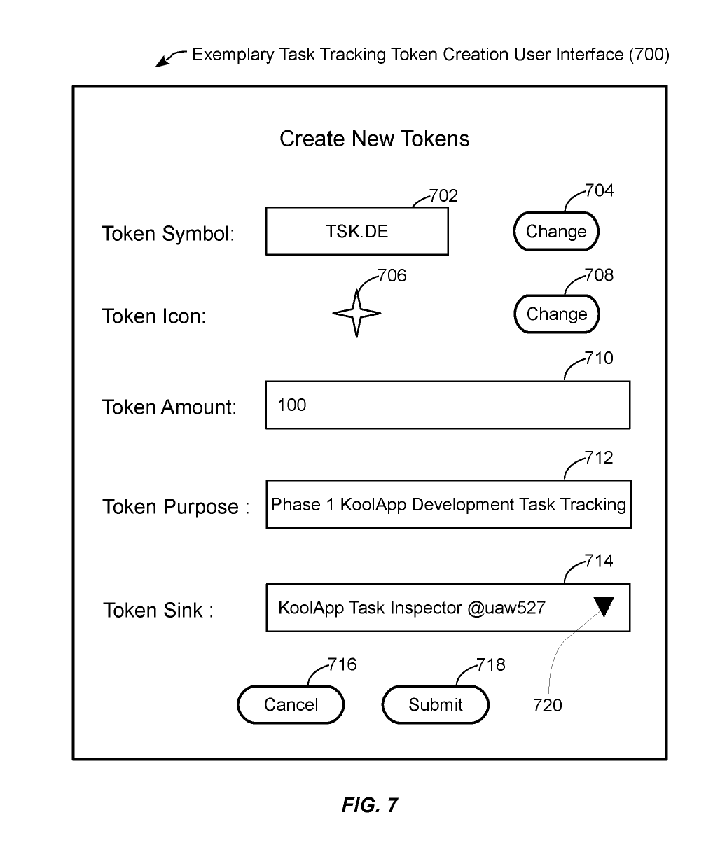

FIG. 7 illustrates the user interface (UI) design and its use 700 in an embodiment of the present invention as applied for task tracking. To create a new task tracking token, a unique unused token symbol may be entered in UI box 702 manually, or UI button 704 may be clicked/tapped to have the system as depicted in FIG. 2 to generate one. The said token symbol may be an alias of the said toke ID that is used to validate said token transaction approval signatures. The mapping between the said token symbol and the said token ID may be stored on the said token transaction clients, and/or on the said token transaction approval nodes, and/or on the said token/transactionchain publishers. While a default token icon is shown at UI element 706, UI button 708 may be clicked/tapped to replace the icon image with an image either from photo galleries or directly from camera photograph. An initial token issuing amount may be entered in UI box 710, while the token to be created may be purpose tagged for task tracking/discharging by entering the corresponding purpose text into the UI box 712. The token receiving address of the said task fulfillment inspector may be entered in UI box 714, while a collection of known token receiving addresses may be listed for selection by clicking/tapping UI element 720. If the user is satisfied with the information entered for task tracking token creation, UI button 718 may be clicked/tapped to submit the token creation request for processing by the corresponding token creation procedures in FIG. 3 and FIG. 4, otherwise UI button 716 may be clicked/tapped to cancel the creation of task tracking tokens.

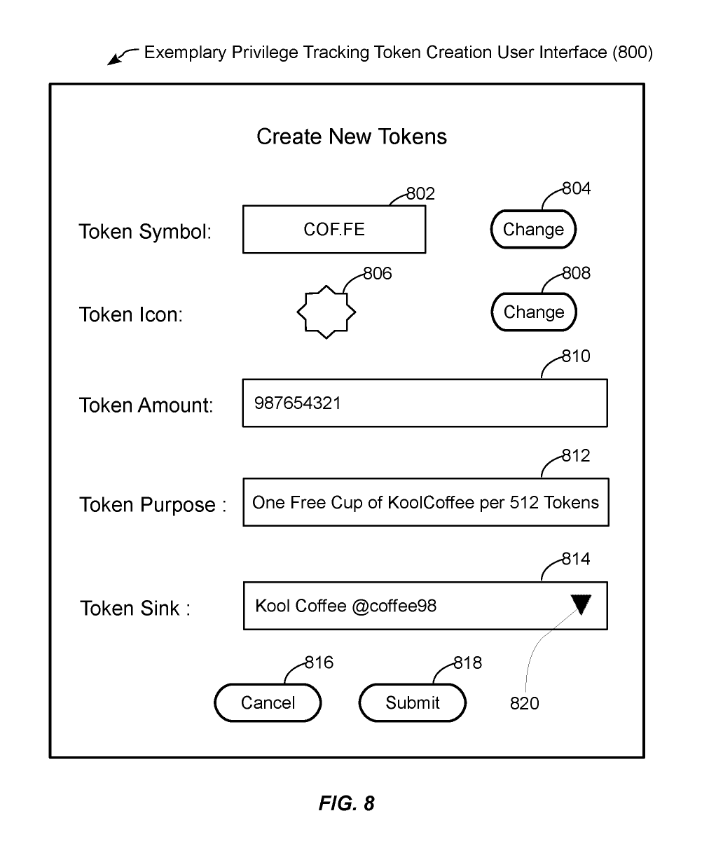

FIG. 8 illustrates the user interface (UI) design and its use 800 in an embodiment of the present invention as applied for privilege tracking and granting. To create a new privilege tracking token, a unique unused token symbol may be entered in UI box 802 manually, or UI button 804 may be clicked/tapped to have the system as depicted in FIG. 2 to generate one. The said token symbol may be an alias of the said toke ID that is used to validate said token transaction approval signatures. The mapping between the said token symbol and the said token ID may be stored on the said token transaction clients, and/or on the said token transaction approval nodes, and/or on the said token/transactionchain publishers. While a default token icon is shown at UI element 806, UI button 808 may be clicked/tapped to replace the icon image with an image either from local photo galleries or directly from camera photograph. An initial token issuing amount may be entered in UI box 810, while the token to be created may be purpose tagged for privilege tracking/granting by entering the corresponding purpose text into UI box 812. The token receiving address of the said privilege granter may be entered in UI box 814, while a collection of known token receiving addresses may be listed for selection by clicking/tapping UI element 820. If the user is satisfied with the information entered for privilege tracking token creation, UI button 818 may be clicked/tapped to submit the token creation request for processing by the corresponding token creation procedures in FIG. 3 and FIG. 4, otherwise UI button 816 may be clicked/tapped to cancel the creation of privilege tracking tokens.

The previously described embodiments of the present invention have many advantages over existing prior arts. It is important to note, however, that the invention does not require that all the advantageous features and all the advantages need to be incorporated into every embodiment of the present invention.

All the features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

While the present invention has been shown and described with reference to certain preferred embodiments, it is to be understood that those skilled in the art may devise certain alterations and modifications thereto which nevertheless include the true spirit and scope of the present invention. Thus the scope of the invention should be determined by the appended claims and their legal equivalents, rather than by examples given.

Any element in a claim that does not explicitly state “means for” performing a specified function, or “step for” performing a specific function, is not to be interpreted as a “means” or “step” clause as specified in 35 U.S.C. § 112, ¶ 6. In particular, the use of “step of” in the claims herein is not intended to invoke the provisions of 35 U.S.C. §112, ¶6.

What is claimed is:

1. A non-transitory machine-readable storage medium containing program instructions for creating and transferring digital tokens cryptographically without the need for periodic centralized authorization to record transactions, said non-transitory machine-readable storage medium configured to:
generating a transaction consent for token creation or transfer, said transaction consent contains token information of the cryptographic public key for verification of transaction approval signatures, of the cryptographic public keys for recipients of said token, and of the addresses of transaction approval nodes for said token; and
signing said transaction consent digitally with the cryptographic private keys of token creators or token transferors; and
directing said signed transaction consent to one or plural of said transaction approval nodes as specified in the said token information; and
validating said signed transaction consent by said transaction approval nodes for said token, forming a corresponding transaction record based on single or plural said signed transaction consents, said transaction record is then digitally signed with a cryptographic private key that can be verified by the said cryptographic public key for verification of transaction approval signatures that is specified as part of said token information.

2. The non-transitory machine-readable storage medium of claim 1, wherein said cryptographic public key for verification of transaction approval signatures is presented directly as the ID for said token, or indirectly one-to-one mapped to the ID for said token.

3. The non-transitory machine-readable storage medium of claim 1, wherein said addresses of transaction approval nodes for said token are website URLs, Email addresses, or SMS phone numbers.

4. The non-transitory machine-readable storage medium of claim 1, wherein said transaction consent comprises transaction outputs for specifying how the token is to be distributed among recipients, and digital signature requirements for future token transfers of the amount being transferred in said token output, said signature requirements include time specification for installment payment fulfillment and revocation.

5. The non-transitory machine-readable storage medium of claim 1, wherein said transaction consent comprises specification of token inputs for the sources of the said token to be transferred from, said transaction consent is sent with transferor signatures that are made by cryptographically signing over token information, transaction outputs, and transaction inputs.

6. The non-transitory machine-readable storage medium of claim 1, wherein said transaction consent is sent with recipient's signatures that are made by cryptographically signing over token information, transaction outputs, and transaction inputs.

7. The non-transitory machine-readable storage medium of claim 1, wherein said transaction consent comprises address information of task or liability fulfillment inspectors so that said token may be used to track task or liability fulfillment and releasing.

8. The non-transitory machine-readable storage medium of claim 1, wherein said transaction consent comprises address information of privilege or permission granters so that said token may be used to track and grant privilege or permission ownership.

9. The non-transitory machine-readable storage medium of claim 1, wherein said transaction consent is redirected to nodes responsible for validating and approving transactions of said token if a node receives said transaction consent and said node is not responsible for validating and approving said transfer consent.

10. The non-transitory machine-readable storage medium of claim 1, wherein the transaction record also contains the hash of at least one previous transaction for the transactions to be chained together, and the transaction approval signature is signed over said transaction chaining hash as well, with exception for the 1^{st} transaction record in the chain.

11. A computer implemented method for creating and transferring digital tokens cryptographically without periodic centralized recording authorization, said non-transitory machine-readable storage medium configured to:
generating a transaction consent for token creation or transfer, said transaction consent contains token information of the cryptographic public key for verification of transaction approval signatures, of the cryptographic public keys for recipients of said token, and of the addresses of transaction approval nodes for said token; and
signing said transaction consent digitally with the cryptographic private keys of token creators or token transferors; and
directing said signed transaction consent to one or plural of said transaction approval nodes as specified in the said token information; and
validating said signed transaction consent by said transaction approval nodes for said token, forming a corresponding transaction record based on single or plural said signed transaction consents, said transaction record is then digitally signed with a cryptographic private key that can be verified by the said cryptographic public key for verification of transaction approval signatures that is specified as part of said token information.

12. The computer implemented method of claim 11, wherein said cryptographic public key for verification of transaction approval signatures is presented directly as the ID for said token, or indirectly one-to-one mapped to the ID for said token.

13. The computer implemented method of claim 11, wherein said addresses of transaction approval nodes for said token are website URLs, Email addresses, or SMS phone numbers.

14. The computer implemented method of claim 11, wherein said transaction consent comprises transaction outputs for specifying how the token is to be distributed among recipients, and digital signature requirements for future token transfers of the amount being transferred in said token output, said signature requirements include time specification for installment payment fulfillment and revocation.

15. The computer implemented method of claim 11, wherein said transaction consent comprises specification of token inputs for the sources of the said token to be transferred from, said transaction consent is sent with transferor signatures that are made by cryptographically signing over token information, transaction outputs, and transaction inputs.

16. The computer implemented method of claim 11, wherein said transaction consent is sent with recipient's signatures that are made by cryptographically signing over token information, transaction outputs, and transaction inputs.

17. The computer implemented method of claim 11, wherein said transaction consent comprises address information of task or liability fulfillment inspectors so that said token may be used to track task or liability fulfillment and releasing.

18. The computer implemented method of claim 11, wherein said transaction consent comprises address information of privilege or permission granters so that said token may be used to track and grant privilege or permission ownership.

19. The computer implemented method of claim 11, wherein said transaction consent is redirected to nodes responsible for validating and approving transactions of said token if a node receives said transaction consent and said node is not responsible for validating and approving said transfer consent.

20. The computer implemented method of claim 11, wherein the transaction record also contains the hash of at least one previous transaction for the transactions to be chained together, and the transaction approval signature is signed over said transaction chaining hash as well, with exception for the 1^{st} transaction record in the chain.
